(19) United States
(12) Patent Application Publication
(10) Pub. No.: US 2007/0101646 A1
(43) Pub. Date: May 10, 2007

(54) Modular planter system

(76) Inventor: Jeff L. Licht, Wayland, MA (US)

Correspondence Address: Jeff Licht, 219 Concord Road, Wayland, MA, 01778, US

(21) Appl. No.: 11/593,713

(22) Filed: Nov. 7, 2006

Related U.S. Application Data
(60) Provisional application No. 60/734,140, filed on Nov. 7, 2005.
(60) Provisional application No. 60/781,779, filed on Mar. 13, 2006.
(60) Provisional application No. 60/781,922, filed on Mar. 13, 2006.

(51) Int. Cl. A01G 9/02

(52) U.S. Cl. 47/86

(57) ABSTRACT

A modular planter system is comprised of high density polyethylene plastic propagation flats, geotextile fabrics, plastic inserts, soil capable of supporting plant, shrub and tree growth, and plants for use on impermeable surfaces. The planter system comprises four similarly constructed units with progressively deeper soil depths achieved through the use of plastic inserts and grouped according to a pre-arranged design. More particularly the planter system is comprised of modules each with its own blended soil, plant material, soil, root retardant, and water retentive non-woven geotextile and inserts. Planters are not connected but installed side by side. Each planter may be moved from its place without having to move other planters. Planter units are assembled ahead of use and transported to the installation site on wooden palettes or via similar conveyance. The planter system can be used with or without edging, and has optional apparati including irrigation and walkable functionalities.

### CROSS-REFERENCES TO RELATED APPLICATIONS

This application claims the benefit of U.S. Provisional Patent Application Ser. No. 60/734,140 filed Nov. 7, 2005, U.S. Provisional Patent Application Ser. No. 60/781,779 filed Mar. 13, 2006 and U.S. Provisional Patent Application Ser. No. 60/781,922 filed Mar. 13, 2006, the disclosures of which are incorporated hereinto by reference.

### REFERENCE TO MICROFICHE APPENDIX

Not applicable.

### STATEMENT REGARDING FEDERALLY SPONSORED RESEARCH OR DEVELOPMENT

Not applicable.

### TECHNICAL FIELD

The present invention relates generally to a plurality of portable, non-interlocking modular planter systems used to support vegetation on impermeable and permeable surfaces. More particularly, the present invention relates to a planter system comprising four similar types of non-interlocking units, methods, research, and apparatus for use thereof.

### BACKGROUND OF THE INVENTION

Briefly, there is nothing new about the use of systems or individual containers, planters or modular devices for vegetative cover on courtyards, terraces, balconies, decks or roofs. Such use dates back thousands of years. In order to support vegetation over time (through all seasons), a variety of containment systems or devices, soil—usually local soil—and plants—usually local plants—evolved. From the hanging gardens of Babylon to the thatched roofs of huts in Asia, to the peat-covered cottages of the Northern British islands and Scandinavia, vegetation was used for practical insulation in winter and summer, livestock browsing and beautification.

After thousands of years of use, vegetated systems have progressed to the point of great specialization all across the world. In contemporary times, outdoor planters used on the ground or on roofs are fabricated from one of several materials including wood, plastic or rubber; plastic, rubber or metal self-contained systems may be either modular or stand-alone vegetative holders. On so-called green roofs, non-modular systems built right on top of the roof membrane are popular as well. Layered roof membranes—combining waterproofing, root retardant, insulation, water retention, drainage elements—may be used to construct lightweight, low-profile vegetated systems, often called extensive, or deeper, often called intensive, loose laid systems.

For terrestrial landscape use, individual or system-like containers may be fabricated on site from railroad ties, plastic, rubber or metal employing either blends of garden or top soil, or mixtures of peat, perlite, vermiculite and shredded bark along with plants of various kinds, depending on climate, seasonality, height and other design considerations. Or they may be pre-fabricated and delivered to the site as stand alone units.

The major difference between modular and loose laid roof systems is obvious on inspection—they are movable, modular roof systems which allow access for roof repairs without a major disturbance to a planted roof system. However, modular systems are typically heavy and difficult to move in a saturated condition.

Planting selection, at least in New England, for modular panels, has not been region-specific. Often, extensive vegetated roof systems—loose laid and modular—have relied heavily on exotic plants. While exotics may be more economic to use, co-evolved species, for example, are just now being tried in their place, as they are inclined in native habitats or on roofs, to be more efficacious in terms of water, and thus a better bet for storm water mitigation.

Storm water capture and mitigation have only recently become a more pronounced goal of system design, and the next generation of modular and non-modular systems will, in all probability, be more intensely focused on the integration of mitigation with landscape design orientation.

The problem until now has been the monolithic—linear rectangles—aspects of modular design. As emulation of natural landscapes and the recognition of soil strata as integral aspects of application emerge even further, the utilitarian approach to modular and non-modular systems will inevitably give way to integrated functionality.

In fact it is this awareness of physical manifestations of sites with sharp drainage, seasonal lack of groundwater, wind, intense sunlight, summer heat effects, that has driven designs described in this invention. The present invention comprises structural amenities to address these important concerns. These include the use of plastics and textiles in combination with soil blends which maximize water retention, atmospheric moisture release in an emulation of ponding effects seen on granite outcrops, seeps, open pinebarrens, cliffs and south facing slopes.

Along with aspirations towards a biomimicked rather than utilitarian approach, the present invention address issues of portability. In the design of the present invention, care was taken to select materials which would be lighter weight than others used by previous inventors of modular systems for both roof and non-roof applications.

The same reasoning was applied to the manufacture of multiple functionalities which might not always be required, but which when required, would be readily available.

The first of these was the concept of walkability—the idea that modules could be built for a pedestrian path on a roof surface for mechanical systems, drain cleanouts which require periodic service or roof repair. The walkable planter met two design goals: provide a fully permeable surface and particular plants for that surface which would survive occasional foot traffic.

Supplemental irrigation of modular planter systems was another concern. Heretofore, somewhat elaborate and complicated irrigation had been made available. With the present invention an attempt was made to simplify the procedure and in doing so to make it a less noticeable system.

Ballast and stability were other concerns as well. Modular systems have not been designed specifically to address ballast and aerodynamic properties which come into play in high wind situations, nor the need to balance these concerns with portability and ease of mobility.

Thus it is clear there is a need for a new and improved system which can address multiple needs on impermeable sites besides green roofs.

### SUMMARY OF INVENTION

The general aim of the current invention was to reduce saturated weight loads, increase water retention, reduce heat island effects, increase mobility, enhance ease of use, increase ecological benefits, simplify irrigation and enhance permeable access pathways for recreation, maintenance and repair.

In so doing, the claimant sought to identify disadvantages of prior systems designed for purposes described above and the benefits and advantages which might be achieved from the use of the invention.

The most important specific benefits derived from the current invention include: (1) portability and mobility of a strong, lightweight frame, (2) superior water retention, root and soil infiltration retardation afforded by the use of two novel geotextiles, (3) customized soil depths in graduated planters using polypropylene copolymer inserts, (4) lower saturated weights from proprietary soil blends, and (4) greater substrate water retention over a longer period of time. Other benefits are described as well.

What follows is a description of drawings which illustrate methods and apparati to achieve those benefits.

### BRIEF DESCRIPTION OF THE DRAWINGS

FIG. 1 is a perspective view of planter A;

FIG. 2 is a section view of planter A showing planter frame with textile layers;

FIG. 3 is an exploded view of planter A showing planter frame, hydrophilic textile layer, non-woven geotextile and entangled core, sand and soil layers, plant layer;

FIG. 4 is a perspective, similar to FIG. 1, view of planter B with two sided insert;

FIG. 5 is a perspective view, similar to FIG. 4, of planter C with three sided insert;

FIG. 6 is a perspective view, similar to FIG. 5, of planter D with four sided insert;

FIG. 7 is a perspective aerial view of planters B, C and D;

FIG. 8 is an aerial perspective view of planters B, C and D;

FIG. 9 is a section view of planter D showing planter frame, hydrophilic textile layer, non-woven geotextile and entangled core, sand and soil layers, inserts;

FIG. 10 is a section view, similar to FIG. 9, of planter D showing planter frame, hydrophilic textile layer, non-woven geotextile and entangled core, sand and soil layers, insert, plants;

FIG. 11 is an exploded view of planter B showing planter frame, hydrophilic textile layer, non-woven geotextile and entangled core, sand and soil layers, inserts, plants;

FIG. 12 is an exploded view, similar to FIG. 11, of planter C showing planter frame, hydrophilic textile layer, non-woven geotextile and entangled core, sand and soil layers, insert, plants;

FIG. 13 is an exploded view, similar to FIG. 12, of planter D showing planter frame, hydrophilic textile layer, non-woven geotextile and entangled core, sand and soil layers, plants;

FIG. 14 is a cross section view of a walkable planter showing planter frame, hydrophilic textile layer, non-woven geotextile and entangled core, “invisible” structure, sand and soil layers;

FIG. 15 is a cross section view, similar to FIG. 14, of a walkable planter showing planter frame, hydrophilic textile layer, non-woven geotextile and entangled core, “invisible” structure, sand and soil layers, plants;

FIG. 16 is an exploded view of the walkable planter;

FIG. 17 is an elevated side view of a pedestrian walking over walkable planters;

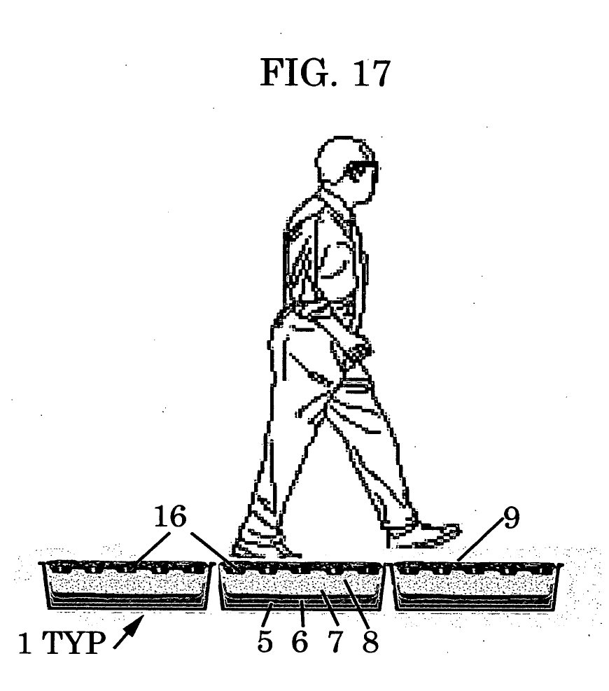

FIG. 18 is a perspective view of A planters placed adjacent to a impermeable surface level with the top of the planters;

FIG. 19 is a side view of a T-connector, bib and drip spout irrigation components;

FIG. 20 is a perspective aerial view of A planters in storage on palette.

### BEST MODE FOR CARRYING OUT THE INVENTION

Detailed description of modular planter system The present invention relates to both terrestrial and roof applications of a modular planter system. The system combines existing products and their functionalities in new ways to achieve superior benefits described in the foregoing sections.

Previously, green roof modular panels (such as those described in U.S. Pat. No. 6,711,851 and U.S. Pat. No. 6,862,842) have been used for application to “green” roofs. While concerns for the water holding function for plant growth were addressed, other significant benefits regarding the maximization of storm water retention and atmospheric redistribution were not. The utilitarian approach taken by the former art which failed to account for the sometimes nuanced relations between root systems, water transport and retention, compaction, and ecological balance achieved with mimicry of vegetative stories—over, middle and under—to afford better plant survival. By using fabrics and plastics which construct a parallel world inside a container which emulates conditions and functions seen in geohorticultural relations in “the wild”, the present invention successfully bridges gaps which have been unfilled until now.

Thus, the importance of layering of fabrics to achieve heightened retention, superior root retardation, superior soil infiltration retardation and prolonged evaporation are crucial to a design improvement. Likewise the fabrication and inclusion of plastic inserts to ramp up soil depths and deepen planting pockets for miniature shrubs and trees afforded the planter system with a unique means to use mimicry of hydrologic and soil horizon profiles found in New England, coastal Mid-Atlantic and maritime eastern Canada to great advantage in terms of biological as well as decorative functions. Many of the plant materials used in the current invention were propagated in soils at the claimant's nursery. These soils mimic natural conditions while standard peat and perlite nursery soils do not. This was another decided advantage from the point of view of early adaptability to a non-irrigation and non-growth stimulator regimen for plants in the modular planter system described herein. To the claimant's knowledge, no other modular product for green roof or landscape container use enjoys this benefit.

The invention consists of four different modular planter units named A, B, C and D. The A planter is the basic core platform from which other planters are constructed. The use of plastic inserts to increase wall height and soil depth contributes to the progressive soil depth differences seen amongst the plurality of planters. The A, B, C and D planters are shown in the figures which accompany this narrative and are referred to throughout in which the same numbers were used to refer to the functional elements shared by all the planters. In the case of the first and several other figures, the numeral 1 is used to denote the basic unit.

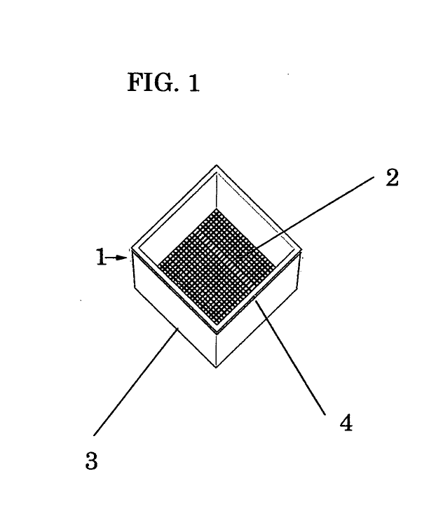

Beginning with FIG. 1, a perspective view of planter A reveals the basic planter module 1 stripped of the balance of the module contents. The A planter starts with a prefabricated, lightweight, sturdy, high density polyethylene (HDPE) propagation tray. The construction provides tensile strength on all four walls 3 without any voids in its interior except tiny drainage squares 2, which accommodate evacuation of water through the bottom of the unit. An integral carrying lip 4 enables a weighted planter to be carried easily and moved from place on an impermeable surface by just one person without mechanical aid. During the past year, the current invention has been used in a number of elementary schools on impervious surfaces. Children weighing approximately 60 to 70 pounds are able to carry the A without any difficulty. One or two children are able to carry A, B and C planters, which will be describer hereinafter, over considerable distances without any trouble. Where D planters were sufficiently deep and heavy—sometime as much as 45 pounds in a dry state—they required some mechanical aid (two-wheeler or the like) for transport over a long distance. However, it should be noted that even the minimum dry (unsaturated) weight of the smallest version of the analogous invention is greater than that of the A planter of the present invention, when comparable surface area and volume area are computed. The prior art (U.S. Pat. No. 6,711,851 and U.S. Pat. No. 6,862,842) requires substantial effort and oftentimes mechanical aid for movement and is thus disadvantageous. For example these units are not light enough to be carried by one or even two children over even a very short distance of a few feet.

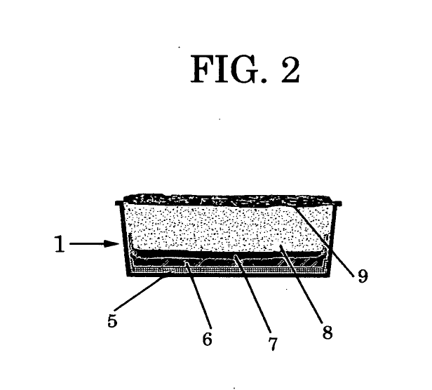

In FIG. 2, the empty module (propagation tray) is enhanced with two fabrics arranged horizontally in two layers beginning with a bottommost layer of hydrophilic fabric 5. Emphatically, the fabrics are a huge factor in the success of the modular planter system. The hydrophilic fabric absorbs and retains as much as twelve times its weight in storm or rain water. The hydrophilic material not only holds water efficiently, it holds more water for longer periods of time than comparative dimpled plastic products. This is an important distinction since dimpled products are the staple for all other modular and all loose laid green roof systems. Repeated tests demonstrated a 500% greater retention amount for the hydrophilic than for a dimpled product used in other systems. The hydrophilic layer, unlike the parallel water retention strategy in the vacuum-formed modular panel, provides root retardation properties, soil infiltration retardation and some modest insulation all in one system. If desired, a second (similarly cut) layer of hydrophilic textile may be placed face downwards against a face-upwards hydrophilic textile (green side to green side). Research carried out this year has shown a doubling of water retention occurs when this procedure is used.

FIG. 2 also portrays a second layer, a non-woven geotextile 6 with an embedded core of entangled polypropylene fibers is placed above the hydrophilic layer. Like the underlying hydrophilic layer, this has one unique property which is superiority to the prior art, namely a root entanglement core. After six months of use, or less, the entangled core fabric may be lifted from the modular planter, and when it is, the entirety or nearly the entirety of plant materials remains attached, and may only be removed with great effort. Here we see a dramatic improvement in stability within the rhizometric zone from the use of this product within the modular planter system. As was reported (Licht and Lundholm, 2006) this layer produces some modest water retention capabilities as well as additional intrarhizometric insulation. These are really minor advantages compared with the entanglement and soil retardation features.

The fabrics shown in FIG. 2 are cut and shaped so as to form an infiltration barrier and maximize water retention. There are several unique advantages to this double fabric system. First, as alluded to earlier, this combination of fabrics mimics a perched water table effect seen in Nature. Second, the two layer system is easily compressed providing maximum compaction during the installation process. This capability contrasts with some other modular and non-modular systems where significant mechanical and non-mechanical recompaction after installation is required. Still another advantage accruing from the use of both textile layers is their durability; these products are constructed with sufficient tensile strength so they do not disintegrate or decompose (see testing by the manufacturers of these products referenced in U.S. Provisional Patent Application Ser. No. 60/734,140 filed Nov. 7, 2005, U.S. Provisional Patent Application Ser. No. 60/781,779 filed Mar. 13, 2006 and U.S. Provisional Patent Application Ser. No. 60/781,922 filed Mar. 13, 2006).

In FIG. 2, another advantage is unveiled with the portrayal of a sand layer 7 topped by the soil media 8 and then the plant layer 9. In this figure one may note the sand layer between the soil and the non-woven geotextile and entangled core layer below substantially protects against clogging of the layer system. This prophylactic layer of sand is effective at clog prevention.

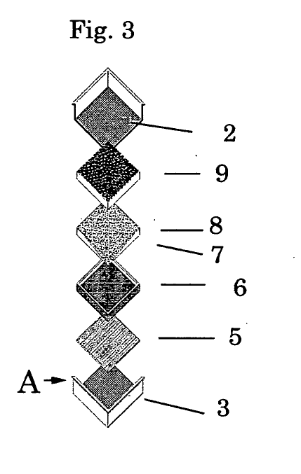

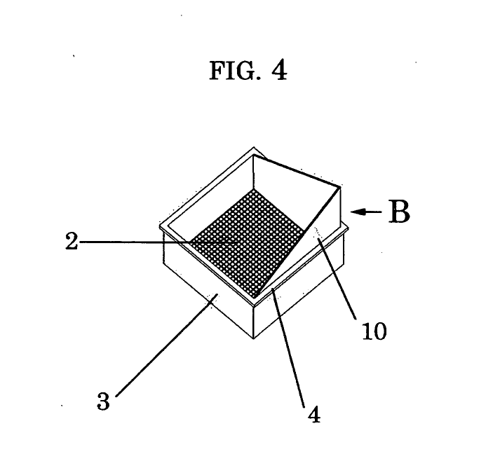

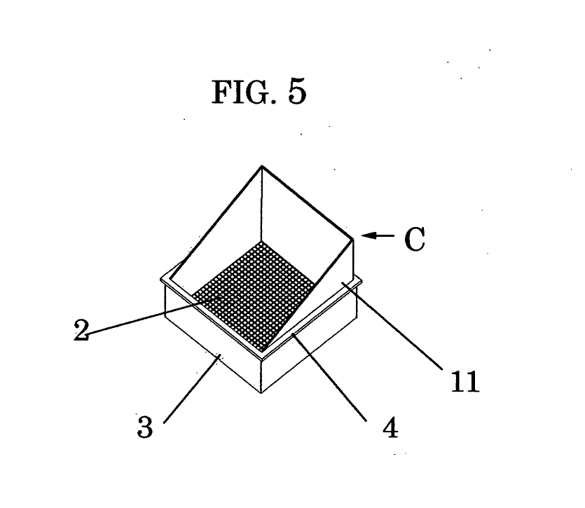

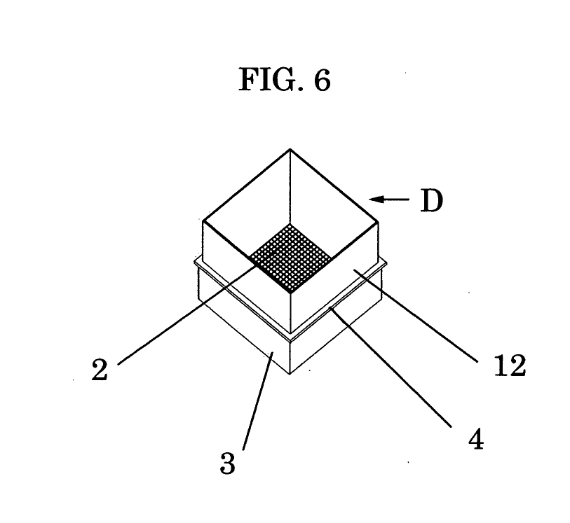

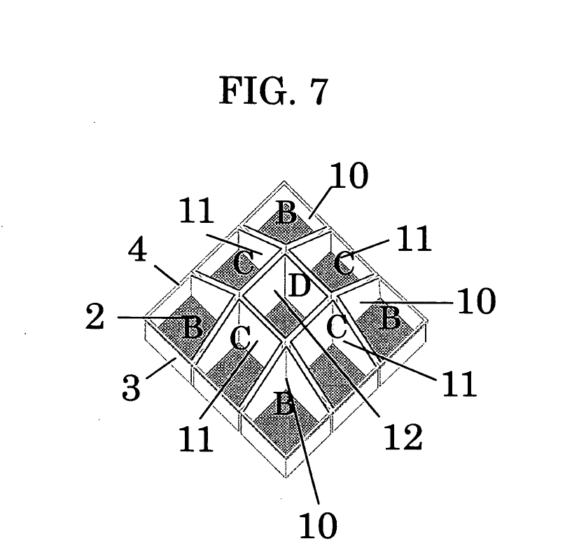

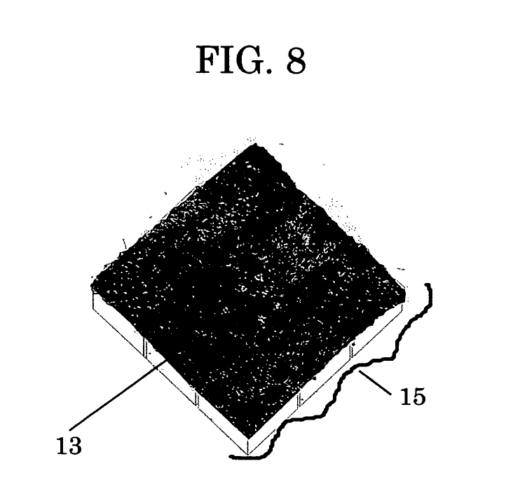

While the A planter makes use of no polyethylene copolymer insert, the other B, C and D planters do. In FIG. 3, the A planter is shown in an exploded view with the hydrophilic layer 5, geotextile and entangled core 6, sand 7, soil 8 and plant layer 9. In FIG. 4, FIG. 5 and FIG. 6, plastic inserts are used to gradually raise the wall height and thus the soil depth for the overall planter system design capability. In FIG. 7 an aerial perspective shows the combined use of B 10, C 11 and D 12 insert-assisted types. In FIG. 8 the results of this approach are shown to good effect from an aerial perspective of herbaceous and evergreen plants forming a mounded effect from side to side and front to back. It should be noted that the inserts may be cut and shaped to form many different angles thus opening up wide possibilities for wall height, soil depth and planter designs. Due to the extreme inexpense of this material, and the extreme expense of separate molded planters for each imaginable slope, it is unlikely that the creation of molds to form completely integral angled propagation flats would become a reality. What is more likely is the creation of separately shaped (round, oval or other shaped) molded planters based on market demand for these other shaped products.

There are several unique aspects to the construction shown in FIG. 8. These include: sculpting of landscape features and provision for co-evolved species with different soil depth requirements but similar soil requirements. The customization of each planter module is strikingly different from the utilitarian approach espoused by other green roof modular or non-modular inventions.

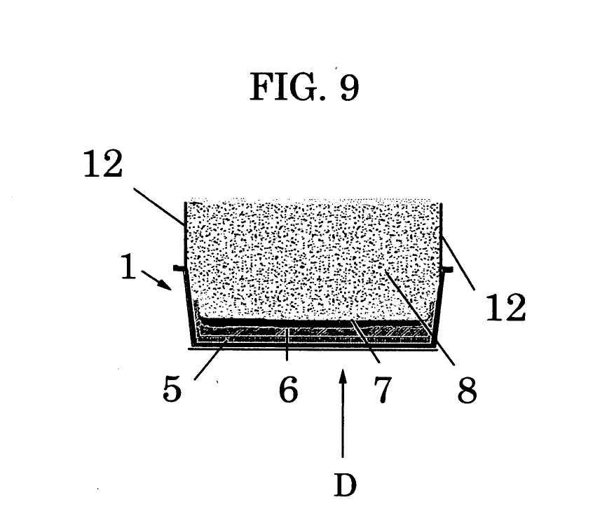

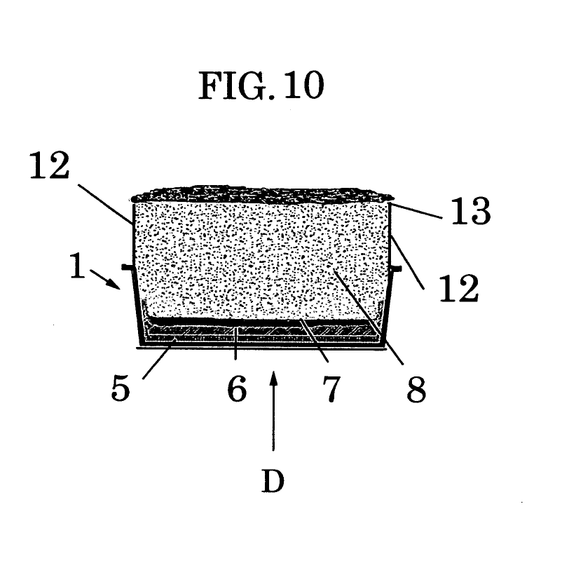

A closer look at the B, C and D planters in explosive views in FIG. 9 and FIG. 10 demonstrate the components which are used for the raised wall systems which can be cut at different angles of repose to raise or lower ultimate soil heights in the B, C and D iterations of the modular planters. The polyethylene copolymer inserts run vertically from the interstitial cavity at the bottom of the planter shell to a predetermined height above the top surface of the shell frame. These apparati are unique to this invention.

The first apparatus is a two-sided insert 10 which culminates in a flattened “V” shape in one corner of the B planter assembly (FIG. 9). The second apparatus is a three sided 11 upside down flattened “U” shape which is formed in two corners of the C planter assembly (FIG. 9). The third apparatus (FIG. 10) is a four sided insert 12 which maintains a uniform soil height all the way around the perimeter of the D planter assembly. Here a layer of herbaceous plants 13 are added to complete the effect.

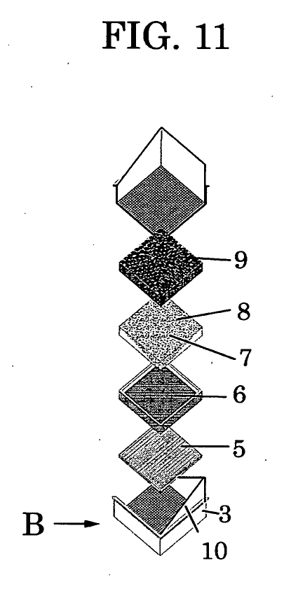

The polypropylene copolymer product used for the wall-building feature is super lightweight but highly rigid and resistant to the buffeting of winds to which planters are exposed. There is also a discernable insulation value to the inserts as they are placed directly against the walls of the planter in front of which are fabrics and soil. FIG. 11 displays an insert system 12 for a D planter which includes plants. Due to the flexibility of these sheets, any size or shape insert can be cut and used in the planters with the restriction being the adding of soil depth and thus overall weight, wherein too much weight would render the system to be more like modular panels and other products which are difficult to maneuver. For landscape use—placement of planters in non-roof situations—these concerns do not apply since, often, the planters are treated as permanent landscape design objects which remain in place and are not moved after installation. In this regard, walls may be built as high as one and one half feet to accommodate deep root systems of woody and even herbaceous plants. Thus, the inserts provide a unique means of deepening, insulating and landscape design which is extremely economic—avoiding the construction of much heavier and cumbersome walls—and simple to fabricate on site. The modular planter system comprises three redundant insulation features which add to the protection of the intrarhizomosphere within the soil layer of the planter system, an advantage over prior art.

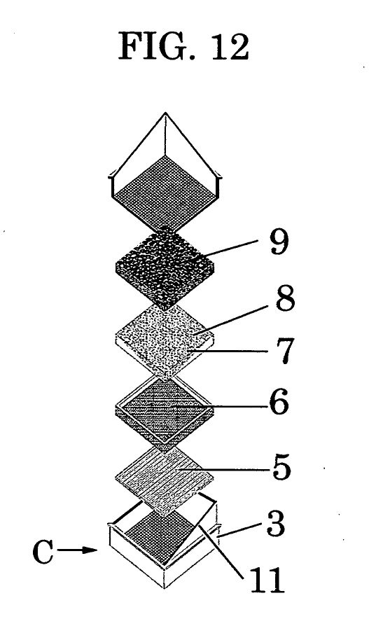

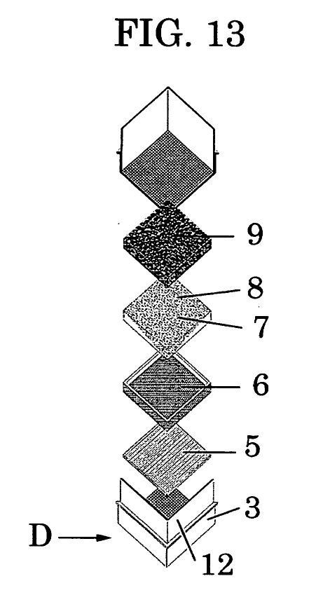

In FIG. 11 and FIG. 12 and FIG. 13, exploded views of planters B, C and D provide another means of understanding the straightforward arrangement of layers to achieve the effects which are unique to said planter system. While not identified specifically, the engineered soil blends 8 which are portrayed in the exploded views are vital to the uniqueness and success of the invention.

The blending of soils is of the highest importance when it comes to the success of portable or even non-portable planting systems. A utilitarian soil such as the one used in the prior art cannot and is not engineered to support a wide variety of herbaceous and woody plants 14 for sunny and shaded modular planter applications. Thus, the modular planter system is unique in that different blends for full sun and shade conditions are used. Examples of these separate but equally important apparati are found on the 8^{th} and 9^{th} floor roofs of Boston City Hall (see Provisional Patent Application Ser. No. 60/734,140).

As we know from past research and practice, simply placing soil of any kind on a roof will lower the temperature during the heat of summer and add some warmth a story below the roof membrane during the winter. By that measure, however, a standard two foot by four foot modular panel with a four inch depth of soil will not insulate as well as a five inch soil depth modular planter covering the same area. Thus, on its face merits, the current art would be more likely to increase cooling and heating effects sought for a building temperature mitigation strategy than another module with a shorter soil depth. However, soil effects are critical for more than building envelope effects. Indeed, studies dating to 1977 illustrate the importance of soil depth for root survival in winter, and the choice of a shallow four inch soil depth is questionable. Thus, the current invention begins with a 5″ depth, corroborated by findings by Boivin et al and Liu and Bass. Layered plants 14, or rather the effects of forest echolalia, have been shown to affect survival in winter and summer when “over”, “middle” and “understory” layers were used. This is a strategy which is unique to the current invention.

The former art does not claim any use of plants shown to be superior for green roof or other permeable surface applications based on demonstrated levels of higher transpiration (E) capacity (correlated with, among other factors, photosynthetic (Pn) and galvanic stomatic (GS) activity). Nor does the prior art report or authenticate multiuse advantages of modular panel systems as compared with those of the present invention (Licht, 2006) when it comes to heat island reduction. Measures of heat island reduction comparing surface and subsurface temperatures were made in 2006 at Boston City Hall using portable EXTECH thermocouple devices indicated a superior cooling effect found in planters using a blend described herein compared with extensive modular panels without this blend. This was simply a comparison of soils as agents of heat island reduction. However, the more substantial difference in favor of the present art is the creation of an empirically tested palette of plants prone to greater evapotranspiration and thus cooling properties 14. In 2006, several genera (and species within these genera) planted in the A planter type in a blend consisting of 70% coarse and 20% fine heat expanded shale and 10% composted and pulverized leaves, were examined with a CIRAS 2 differential analyzer in separate trials in Medford, Mass. after exposure to the equivalent of a one inch rain event. E, Pn and GS, and related measures were found to be positively correlated. Thus, plants were isolated and ranked in terms of evaporative superiority. These proprietary findings were applied to the development of a plant palette especially for clients interested in maximizing evapotranspiration of storm water for plants with the highest ET rates. No such research or applications of research to plant specifications for use in modular systems has been claimed in prior art.

After trials of non-expanded soil products and expanded shale, the claimant found greater water retention and slower moisture release from retained water used in all of the soil blends referred to herein (see also U.S. Provisional Patent Application Ser. No. 60/734,140 filed Nov. 7, 2005; U.S. Provisional Patent Application Ser. No. 60/781,779 filed Mar. 13, 2006 and U.S. Provisional Patent Application Ser. No. 60/781,922 filed Mar. 13, 2006). Studies, especially those at Pennsylvania State University, over the past decade, bear out the direction and purposefulness of the present claimant's assertions. The coarse expanded shale products used in the planters are different from those used in the modular panels. Comparisons of the planters and modular panels in terms of dry and saturated weights of soils indicate a superiority of the approach taken by the claimant with regard to the most critical requirements: (a) amount of water retained and (b) amount of weight by area×volume of containment during and after soil media saturation (Licht, 2006).

Interestingly the soil blends used for the present art are not only lighter in weight but when used with the fabrics described earlier, absorb a greater amount of water and retain more water over a longer period of time. Research by the claimant and others has shown that individual plants selected for use in applications for a variety of impermeable surfaces require blended “soils” which are more less water retention, a higher or lower macro and micronutrient composition, or more or less porous, have a higher or lower pH, a higher or lower electrical conductivity, or more or less loose or compacted. The advantage to the present invention is that as many as fifteen different blends of soil are available for use in the modular planter system (blend formulae were referenced in U.S. Provisional Patent Application Ser. No. 60/734,140).

The soil blends which are unique to this invention are dependent on the availability and use of specific organic content. While other, prior art may, in time, make use of coarse or fine a heat expanded shale or slate, and mason's (or “USGA”) sand, the organic content (screened and composted yard waste) used in the invention derives from only one source—whose products are inspected and approved by the Commonwealth of Massachusetts. All soil products used in modular systems besides the present invention are created far away in other States where the organic component is not located or available. In cases where a similar product is available in some other State, no claim has been made, thus far, by the maker of the prior art, to utilize such an ingredient, nor have any test results of such use been included in the previous patent claim.

Blends used in the present invention, both by formula as well as composition, are unique. The blends were fabricated according to specific plant requirements based on specific horticultural, geotechnical, field ecology and hydrologic knowledge of interactions of plants and “manmade” soils which emulate conditions governed by these four specialized knowledge bases. The blends are trade secrets which are balanced according to nutrient, porosity, electrical conductivity, pH, absorption and other factors critical to growth and continued health. The blends consist of three main components: heat expanded aggregate, sand and organics which are formulated to match perceived needs of plants. Typically, the A planters are designed with either an 80% coarse and 20% organics mix or a 70% coarse, 15% fines and 15% organics mix or blends which lie somewhere between. Typically, B, C and D planters are designed with either a 65% coarse, 10% fines, 10% sand and 15% organics, or a 70% fines, 10% sand and 20% organics mix or somewhere in between. Variations of these blend formulae were used where either sharper drainage or less drainage was required. In those cases, a larger amount of coarse material was used where more drainage was desirable, and less coarse material where less drainage was deemed desirable.

Drainage is another paramount concern. The structure of the present art contains rows of square drainage holes which allow excess storm water not captured in the layers above to exit the unit. The beauty of this simplified drainage is that it cannot be clogged due to soil infiltration retardation from the fabrics located above it. One of the concerns about other modular systems is the opportunity for soil to work its way through a system into one or more of the dimpled drainage ports and clog the small pinholes which afford overflow drainage.

Aerodynamic qualities 15 as referenced with a curved underlining in FIG. 8 are important as well. As seen in the exploded views of all the planters, one sees the flattened profile which reduces drag to a minimum in relation to boundary layer and laminar flow effects. Prior modular arts feature interlocked or bolted down modular systems with bottoms which are less aerodynamic such as the prior art with voids susceptible to aerodynamic lift. The present invention has been demonstrated to withstand significant multidirectional wind forces at an installation site at the peak of the Blue Hills in Canton, Mass., whose elevation is consistent with that of the topmost portion of the John Hancock building in Boston, Mass. According to tests performed at the Massachusetts Institute of Technology and elsewhere, as early as the 1970's, geotechnical physicists found that approximately 15 pounds per square foot was thought to be the minimum requirement for ballast against multidirectional wind forces; the claim by the maker of prior art suggests a 12-15 pound per square foot range. Our media typically weighs a minimum of 14.6 pounds dry per square foot (at a depth of five inches) for the coarsest media and as much as 30.6 pounds per square foot where the predominant blend component is 70% fine aggregate (heat expanded shale) which is much denser and heavier than the coarse aggregate.

It should be noted these blending and mix factors are just as important for planters used on impermeable surfaces “on the ground”, such as courtyards, schoolyards, terraces, patios and the like. Besides being important in terms of promoting plant health, the other concern is stability. In non-roof situations, wind conditions, even with gusts, are generally lighter (less forceful) than those found on roofs, especially where air pressures changes resulting from abiatic, viscous resistance or other causes can suddenly or continuously generate greater turbulence. Yet, the ballast afforded by the said planters is as good as or better than that found in other, analogous inventions weighing much more per cubic foot.

Another distinct advantage of the present module is resistance to wear from continuous exposure to direct ultraviolet sunlight. Claims for its longevity by a number of academic institutions and eighteen years of observation in Wayland, Mass. testify to the durability of the propagation tray product.

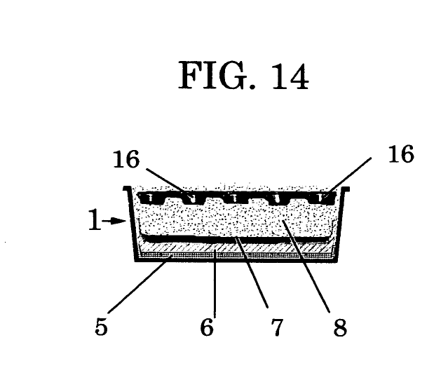

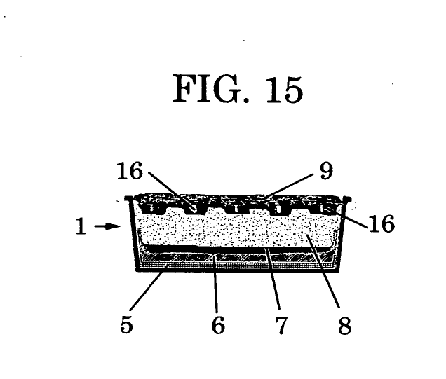

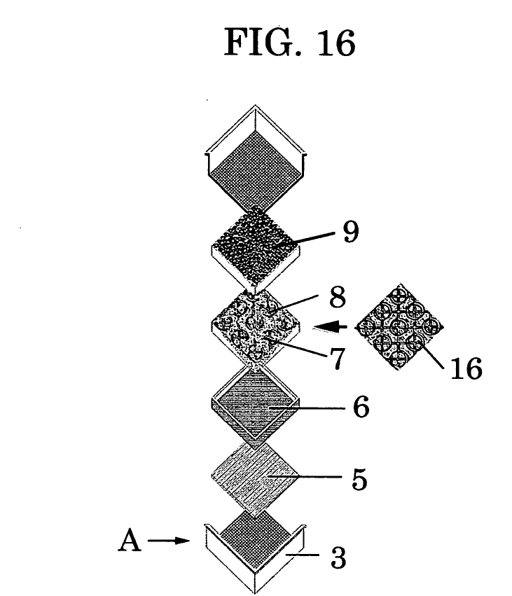

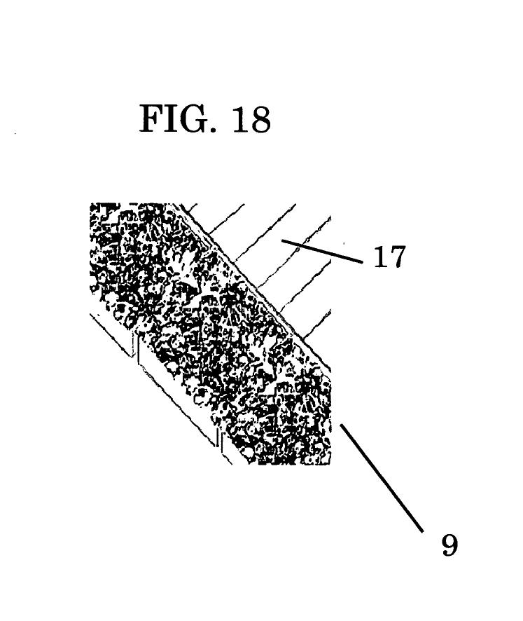

Structural differences also are apparent in the concept of a walkable modular planter described in the present invention. In FIG. 14, an A planter is used to create a walkable module which joins the other members of the planter family in the current invention. As can be seen in FIG. 14 and FIG. 15, an HDPE grid 16 was used to form a stabilized surface for ease of pedestrian access. The grid is a contiguous, interconnected set of rings of hollow cells. A closer look at the way in which the grid is used can be found in FIG. 18 where an exploded view depicts an isolated section of the grid and then placement of the grid 16 within the soil layer. When placed in the soil media layer, it can be used in two ways: either as a stand-alone or planted with one or more genera found by the claimant to tolerate infrequent exposure to foot traffic (Licht, 2006). The advantage is clear: this invention provides pedestrian access (shown in FIG. 16) to recreational space or access on impermeable surfaces or roofs where HVAC, drains or other systems require periodic inspection or maintenance.

There are four other supplemental aspects to the current invention. The first concerns the bioengineering of a modular planter system to produce the maximum amount of environmental and ecological benefit. Heretofore no mention nor design nor implementation of specific strategies regarding bioengineering was anticipated nor done for modular or non-modular systems. As noted earlier, plants were found to have essential value as contributors to cooling effects. Another value is somewhat more nuanced and that has to do with geohistoric adaption to drought. Typically, subjects derived from mountain summits, coastal communities, rock cliffs, serpentine forests, uplands, pine barrens, heaths or similarly identifiable geo-horticultural communities are thus inclined (Licht and Lundholm, 2006). Several criteria were used to qualify plants from such locales for testing and eventual employment including: cold, heat, drought and wind tolerance, ornamental attractiveness and fibrous roots which tend to retain water efficiently. The B, C and D planters are designed for deeper soil depths allowing plants with deeper rooting systems to grow and survive in said units.

Twenty years of observation of plants in situ in New England, by the claimant, provided the background for comparative studies of native and non-native plants and their use in man-made landscape systems use on permeable and impermeable surfaces. Bioengineering took the form of soil blending, plant selection and testing of plants according to specific criteria which would suggest both seasonal pollination and properties of superior evapotranspiration. Testing of endemics from New England, the Mid-Atlantic and Southern Appalachians, provided both a bloom sequence (sufficient nectar material to encourage pollinators to return over and over for sequential nourishment) and biomass calculations for a roughly 230 square inch area (the surface area of the present invention).

Observations of system planters and their modular panel counterparts on a roof at Boston City Hall were made of same-size square foot quadrants. A conscious effort was made to install forty-five species of herbaceous and woody plants in fifty four planters of the current invention which would bloom in overlapped sequence between mid-April and early November. Hundreds of comparative modular panels located on either side of the current invention were planted with a mixture of herbaceous plants which bloomed predominantly between May and July (with the exception of Talinum calycinum). Pollinator visits were observed during non-sequential twenty minute observation segments over a period of months of both modular panels and planters. The clear superiority of timed visits to the planters as opposed to the modular panels based on available nectar amply demonstrates the application of the principle of extended blooming sequences for balanced ecology. The value of co-evolved species as a part of pollinator encouragement was also observed in the planters—there were no co-evolved species in the modular panel containers.

After biological, geotechnical and hydrological concerns are addressed, one is still left with the need to integrate those advances found in the present invention with design capability which addresses beautification and aesthetics tied to Nature and environmental mitigation. The increasingly graduated heights of planters B, C, and D as depicted in FIG. 8 provide a landscape opportunity which cannot be emulated by the prior art for a number of reasons. First, the structural composition of the prior art comprises static, linear and monolithic layers of vegetation in a building block orientation with no apparent relation to the non-built (natural) environment. Second, the A, B, C and D planters can be used in many configurations which allow texture, height, depth and other factors play off against desirable environmental benefits.

A side-by-side configuration of planters is fairly simple to lay out and is obviously a feature shared by many systems. In terms of alignment with thresholds, or “seams” between deck flooring or pavement or tile or similar surfaces 17, planters are required to meet other surfaces seamlessly so pedestrian footfalls are uninterrupted. The current invention takes into account both access and recreational needs; FIG. 18 displays a view reflecting module to non-modular surface alignment.

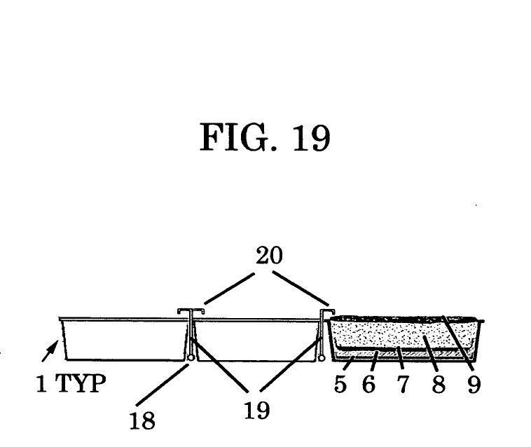

Prior art has conceived of adjunct watering capability to promote irrigation for various purposes. However, one of the most obvious limitations noted in the design of prior art for this purpose was the amount, type, complexity and expense of such a system. In the present art, the value of a unique semi-hidden system should be somewhat evident for aesthetic as well as practical purposes. As portrayed in FIG. 19, an adjunct watering system for irrigation (during times of extreme drought) was designed. It took advantage of an 80 degree cant rising from the bottom of the plastic planter to the top, where a cavity between adjacent planter walls enables irrigation tubing to be inserted between them, through a hole in the integral lip over the top edge of one side of the planters, to afford irrigation, as needed, for each individual unit.

Depending on the design, where planters are required to receive irrigation, a simple system as shown in FIG. 19 applies existing irrigation water supply line technology (e.g., a DRAMM or RainBird drip irrigation system) to each planter through a T-connector 18, bib 19 and water line feed which terminate in a drip spout 20 suspended over the planter wall edge. Thus, one or more planters, up to a plurality of a planter layout, can be serviced by irrigation with only the small extender irrigation feeds being seen from above.

Planters are fabricated well in advance of need—the longer the planters have to habituate to climate without ancillary chemicals and over-watering as is typical for module and modular panel plantings, the more easily they manage themselves with little care after placement on any impermeable surface from ground level to roofs. Thus even the storage and maintenance of the current invention is done in a unique way, combining organic growing, no irrigation after establishment and hardening off of planted materials well before they are needed.

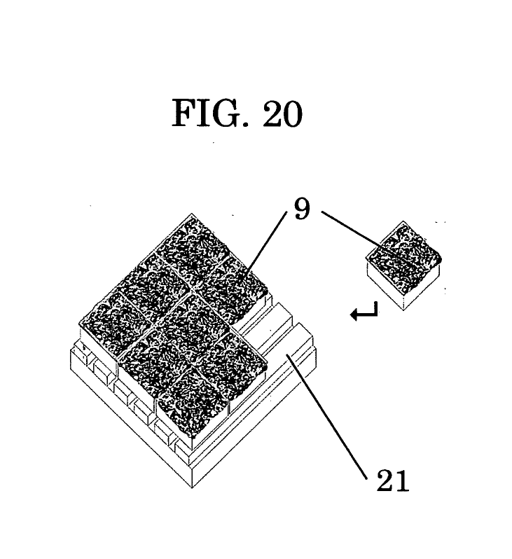

The transport of the planters is another unique and simplified approach which is tackled by the design of the planter system. In order to avoid the cumbersome lifting, manipulation, mechanical movement of larger modules and modular panels, the current invention makes use of lightweight modules which are easily stored and conveyed on readily available wooden palettes 21 as shown in FIG. 20.

Based on these advantages, it is clear there is a need for a new and improved system for impermeable surfaces which speaks to the various constituent needs addressed above. The present invention also comports to the advantages claimed by the prior art. These include the fact that planters like modular panels are more easily installed than prior green roof module systems; can be installed over existing roofing material on existing buildings with a slope of up to twenty-five degrees; can eliminate the need and associated costs to install completely new roofing membranes or existing green roof system; enhance design flexibility and the ability to change the design layout after initial installation, and may be used as a stand-alone system or in combination with other (prior or current) green roof systems.

What is claimed is:

1. A modular planter system comprising: a plurality of planters resting on an impermeable surface, in a side by side relationship, each planter having a bottom and side walls extending upwardly therefrom to define a perimeter, wherein wall height and soil depth is increased through the use of plastic inserts, to contain geotextile fabrics, a layer of sand, a layer of engineered soil media and a layer of plants, with a bottom comprised of drainage holes therethrough, permitting the flow of water, not captured in the planter, to flow to the surface underneath, the sides having an integral lip surrounding the perimeter thereof, which allows the lifting of an individual unit, without disturbance to adjacent planters.

2. A modular planter system of claim 1 further including a plurality of modular planters containing a geotextile fabric layer, a sand layer, an engineered soil media layer, a plant layer and a two-sided polypropylene insert.

3. A modular planter system of claim 1 further including a plurality of modular planters containing a geotextile fabric layer, a sand layer, an engineered soil media layer, a plant layer and a three-sided polypropylene insert.

4. A modular planter system of claim 1 further including a plurality of modular planters containing a geotextile fabric layer, a sand layer, an engineered soil media layer, a plant layer and a four-sided polypropylene insert.

5. A modular planter system of claim 1 wherein the underside of said planters minimizes flow of unretained water (which passes through the soil and fabric layers) through a combination of geotextile, sand, engineered soil and plant layers.

6. A modular planter system of claim 1 further comprising: an integral lip used for lifting or moving or placing said planters, to gain access to nearby mechanical or drainage systems, to add or remove one or more plants, to adjust the positioning of one or more said planters in relation to others, or move to allow repairs to a roof or other surface.

7. A modular planter system of claim 1 comprising: a plurality of modular planters with an integral lip modified to accept apparatus for supplemental drip irrigation.

8. A modular planter system of claim 1 comprising: a layer of hydrophilic composite polyester cut and fit horizontally to the bottom of said planters whose properties include water absorption capability, root retardation and tensile strength, located in each said unit.

9. A modular planter system of claim 1 comprising: a layer of non-woven geotextile and entangled fabric cut and fit horizontally to overlay the hydrophilic composite polyester in the bottom of said planters whose properties include root retardation, fine particle retention, tensile strength, water draining capability and encouragement of root entanglement, located in each said unit.

10. A modular planter system of claim 1 comprising a sand layer poured on top of a non-woven geotextile and entangled fabric in said planters.

11. A modular planter system of claim 1 comprising a layer of engineered soil media poured on to a sand layer, comprised of heat expanded shale or slate, screened composted yard waste, to promote the establishment and growth of herbaceous, deciduous, persistent evergreen or evergreen plants, shrubs and trees in said planters.

12. A modular planter system of claim 1 further comprising the inclusion of plants, shrubs and trees selected, propagated and grown in a media devoid of insecticide, herbicide or growth stimulators in said planters.

13. A modular planter system of claim 1 further comprising an irrigation apparatus inserted for use in said planters.

14. A modular planter system of claim 1 further comprising an arranged group of said planters which may be edged with wood, rubber or plastic, whose terminus results in a ninety degree miter or square edged corners according to a pre-determined design.

15. A modular planter system of claim 1 further comprising the use of said system for multiple level designs for installation on terrestrial or roof impermeable surfaces, and, where required, in combination with non-planter systems such as loose laid green roofs or non-planter terrestrial installations.
